(19) United States
(12) Patent Application Publication
(10) Pub. No.: US 2017/0001468 A1
(43) Pub. Date: Jan. 5, 2017

(54) PAINT ROLLER HOLDER

(71) Applicant: Peter Stasack, Rensselaer, NY (US)

(72) Inventor: Peter Stasack, Rensselaer, NY (US)

(21) Appl. No.: 14/790,289

(22) Filed: Jul. 2, 2015

(51) Int. Cl. B44D 3/12; B65D 25/28; B65D 25/40

(52) U.S. Cl. CPC B44D 3/125; B44D 3/123; B65D 25/40; B65D 25/28

(57) ABSTRACT

A paint roller holder that includes: a container; a sloping side of the container; a series of roller ribs along an inside wall of the sloping side of the container; and a roller holder on a second inside wall of the container. The paint roller holder may further include a set of wheels to support the container and a handle. Preferably, the container also includes a push button spout to release fluids from the container.

### BACKGROUND OF THE INVENTION

Field of Invention

The present invention relates to a container which is used to hold, clean and maintain paint rollers.

Description of Related Art

It is well known painting is a task that involves brushes and rollers to spread paint over a surface. Rollers are used on many occasions to apply paint over a surface due to the quickness and ease that is associated with a roller. Brushes are also used for application of paint and are necessary in certain areas during paint application. One aspect of painting involves the cleaning and washing of the rollers and brushes after the painting is complete. If the rollers and brushes are not properly cleaned and maintained then they can become hard and difficult to use more than once. As a result, it would be advantageous to have equipment particularly designed to address the cleaning and storage of rollers in particular. Rollers are generally more difficult to clean and maintain as opposed to a paint brush.

### SUMMARY OF THE INVENTION

The present invention relates to a paint roller holder that includes: a container; a sloping side of the container; a series of roller ribs along an inside wall of the sloping side of the container; and a roller holder on a second inside wall of the container. The paint roller holder may further include a set of wheels to support the container and a handle. Preferably, the container also includes a push button spout to release fluids from the container.

### BRIEF DESCRIPTION OF DRAWINGS

FIG. 1 depicts a paint roller holder in accordance with the present invention.

### DETAILED DESCRIPTION

The present invention relates to a paint roller holder that is used to clean, maintain and store paint rollers when the rollers are not in use. The container also can be used to assist in the cleaning and maintenance of the roller after work is complete. The container of the present invention includes a lid but more uniquely includes a sloped side. The sloped side includes a series of holders or ribs that are aligned along the inside wall of the sloped side. These ribs provide a means to mount and secure paint rollers within the container. During use these rollers can be cleaned within the container and then stored along the ribbed side to be allowed to dry and drip as necessary. In one particular embodiment, this container is a 19-gallon sized container that preferably is portable with the use of wheels at the bottom of the container.

Further a paint roller holder is on the inside of the container to allow for the placement of the roller during the cleaning process.

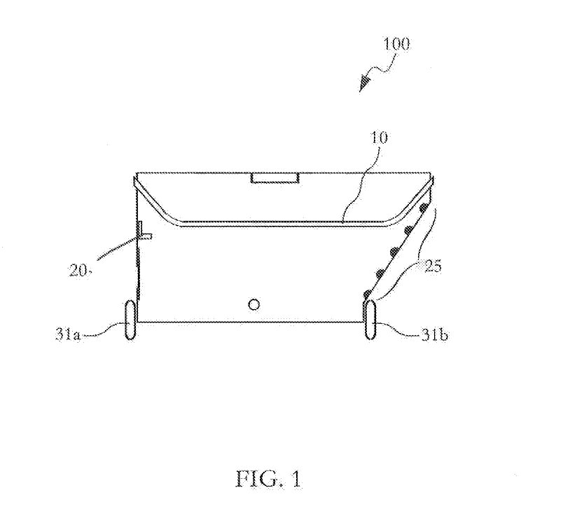

With respect to FIG. 1, a paint roller Container 100 is depicted. The Container 100 includes a sloped wall 25 that includes a series of ribs along the inner surface of the sloped wall. These ribs are for the placement of rollers along this wall during use. Further a roller holder is also on the inside surface of the Container 100. This holder allows for the user to place a paint roller in position for cleaning purposes. After cleaning is complete, the roller may be placed in one of the ribs to allow for dripping and drying of the roller. The Container 100 also includes a spout at the bottom center of the container. The spout allows for any liquids from the container to be dispensed while cleaning the rollers.

Further features related to the container include a handle 10 that is used to move the container on wheels 31a, 31b provided. The wheels 31a, 31b allow for easy movement of the Container 100 during use. An opening in the top of the lid is provided with a lid although not shown that allows for the closure of the container when not in use. The instant invention has been shown and described in what it considers to be the most practical and preferred embodiments. It is recognized, however, that departures may be made there from within the scope of the invention and that obvious modifications will occur to a person skilled in the art.

1. A paint roller holder comprising:
a. a container;
b. a sloping side of the container;
c. a series of roller ribs along an inside wall of the sloping side of the container, wherein said ribs are adapted for placement of paint rollers; and
d. a roller holder on a second inside wall of the container, wherein the roller holder is adapted for placement of a paint roller during cleaning.

2. The paint roller holder according to claim 1, further including a set of wheels to support the container.

3. The paint roller holder according to claim 1, further including a handle.

4. The paint roller holder according to claim 1, further including a push button spout.

5. A system for supporting paint rollers during cleaning comprising:
a. a container, where the container includes a sloping side;
b. a roller holder, where the roller holder holds a roller in place during cleaning;
c. a series of roller ribs on an inside wall of the sloping side, where the series of roller ribs receive paint rollers;
d. a release spout at the bottom of the container; and
e. a lid to seal the container when the container is not in use.

6. The system for supporting paint rollers according to claim 5, further comprising a set of wheels on the container for mobility purposes.
